(19) United States
(12) Patent Application Publication
(10) Pub. No.: US 2017/0245459 A1
(43) Pub. Date: Aug. 31, 2017

(54) PET TOILET

(71) Applicant: ELLIS HALLIDAY LLC, Houston, TX (US)

(72) Inventor: Jeni Ellis Halliday, Houston, TX (US)

(21) Appl. No.: 15/509,707

(22) PCT Filed: Sep. 15, 2015
(86) PCT No.: PCT/US15/50285

§ 371 Date: Mar. 8, 2017

Related U.S. Application Data
(60) Provisional application No. 62/050,575, filed on Sep. 15, 2014.

(51) Int. Cl. A01K 1/01; E03D 11/11; E03D 5/10

(52) U.S. Cl. CPC A01K 1/011; E03D 5/105; E03D 11/11

(57) ABSTRACT

Exemplary embodiments of a pet toilet are provided. A pet toilet is provided having a base, a standing surface provided on the base configured to allow a pet to stand on the standing surface, a first flush mechanism to provide water for flushing the standing surface, a rim tube connected to the first flush mechanism configured to provide water from the first flush mechanism to the standing surface, and at least one water outlet disposed on the rim tube for providing water from the first flush mechanism to the standing surface. The flush mechanism can be an automatic flush mechanism triggered by one or more motion sensors. The standing surface can have a concave surface.

### CROSS-REFERENCE TO RELATED APPLICATIONS

This application relates to and claims priority from U.S. Provisional Patent Application Ser. No. 62/050,575 filed Sep. 15, 2014, the entire disclosure of which is hereby incorporated herein by reference.

### FIELD OF THE DISCLOSURE

The present disclosure relates to exemplary embodiments of a pet toilet, and more particularly, to exemplary embodiments of a pet toilet apparatus for pets to stand upon.

### BACKGROUND INFORMATION

The present disclosure relates to pet toilets and particularly to pet toilets that are connectable to a sewage drain and that operate automatically.

An enormous problem for pet owners, particularly those who live in urban high population areas, is the problem relating to pet bodily waste, and specifically for dog owners. When the weather may be extreme (hot or cold) and difficult for an owner to take a pet outside, or when an owner's job or other factors do not allow for them to come home to the pet in time to take them outside, it can create an enormous problem for the pet and the pet owner. Another problem is in the case of service and therapy dogs. Often, a disabled owner has difficulty with pet waste indoors, must incur the risks of walking the animal outdoors or use pet pads that are odorous and wasteful.

Even when a pet owner can walk its pet outdoors several times a day, no fully satisfactory location can be found for the elimination of fecal wastes and urine is unable to be picked up. Elimination on the sidewalk, on the street curb or on lawns raises obvious objections, as does elimination in trash bins due to the unpleasant odors, bacteria and parasites.

Therefore, there is a need for a pet toilet that can be provided for residential, commercial or public use, that can be permanently installed and connected to existing drains, and can provide for an automatic and/or manual flushing system.

### SUMMARY OF EXEMPLARY EMBODIMENTS OF THE DISCLOSURE

At least some of the above described problems can be addressed by the exemplary embodiments of a pet toilet of the present disclosure.

In some exemplary embodiments, a pet toilet can be provided comprising a base, a standing surface provided on the base configured to allow a pet to stand on the standing surface, a first flush mechanism to provide water for flushing the standing surface, a rim tube connected to the first flush mechanism configured to provide water from the first flush mechanism to the standing surface, and at least one water outlet disposed on the rim tube for providing water from the first flush mechanism to the standing surface.

The pet can further comprise a drain provided in the standing surface configured for removal of pet waste and water from the water outlet. The drain can be located at a lowest portion of the standing surface. The pet toilet can further comprise a tank for providing water flow to the first flush mechanism. The pet toilet can further comprise one or more motion sensors provided underneath the tank for detection of a pet on the standing surface. Upon detection of a pet leaving the standing surface the one or more motion sensors trigger the first flush mechanism.

The pet toilet can further comprise a side wall located adjacent to the standing surface along a rear circumference of the standing surface. The side wall be located along approximately less than 50% of the circumference of the standing surface. The side wall can be substantially vertical and has a curved surface. The pet toilet can further comprise a second flush mechanism for flushing the side wall of the pet toilet. The pet toilet can further comprise one or more motion sensors provided along an inner surface of a top wall opposite the side wall for detection of a pet on the standing surface. Upon detection of a pet leaving the standing surface the one or more motion sensors can trigger the second flush mechanism.

The rim tube can be provided along at least a portion of a circumference of the standing surface. The pet toilet can further comprise several water outlets provided along the rim tube. The at least one water outlet disposed on the rim tube can provide water flow at an angle to provide clockwise or counterclockwise water flow on the standing surface.

The pet toilet can further comprise a cutout portion on the base allowing a pet access to the standing surface. The pet toilet can further comprise a sprayer attached to the pet toilet that provides a water outlet for cleaning the pet toilet. The pet toilet can further comprise a macerator for receiving waste from the standing surface. The macerator can be configured to be connected to an existing sewer line.

### BRIEF DESCRIPTION OF THE DRAWINGS

The foregoing and other objects of the present disclosure will be apparent upon consideration of the following detailed description, taken in conjunction with the accompanying exemplary drawings and claims, in which like reference characters refer to like parts throughout, and in which:

FIG. 1 is an illustration of a perspective view of a pet toilet according to an exemplary embodiment of the present disclosure;

FIG. 2 is an illustration of a top view of a pet toilet according to an exemplary embodiment of the present disclosure; and

FIG. 3 is an illustration of a cross-section of a side view of a pet toilet according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

Exemplary embodiments of the pet toilet of the present disclosure will now be described with reference to the figures. The following description of the various embodiments is merely exemplary in nature and is in no way intended to limit the scope of the disclosure, its application, or uses.

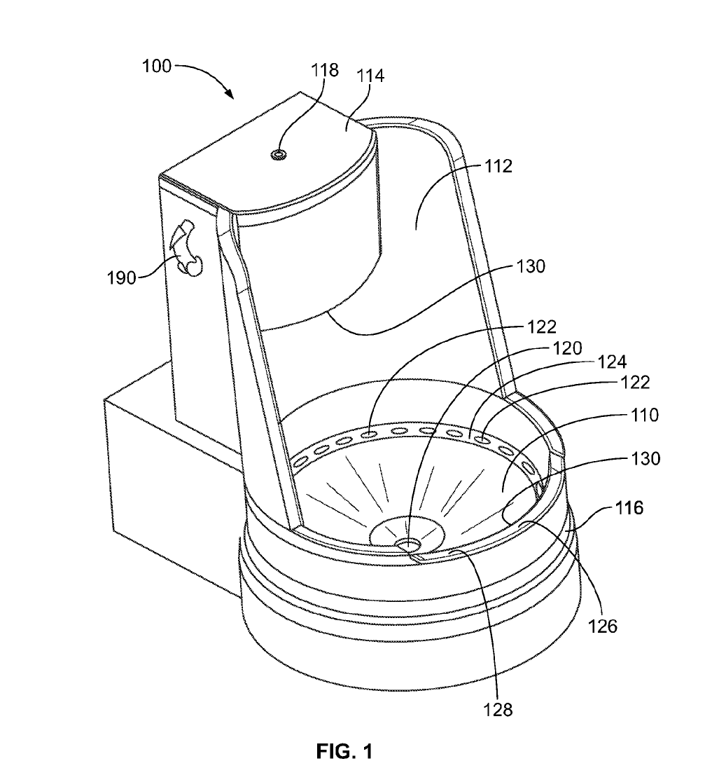

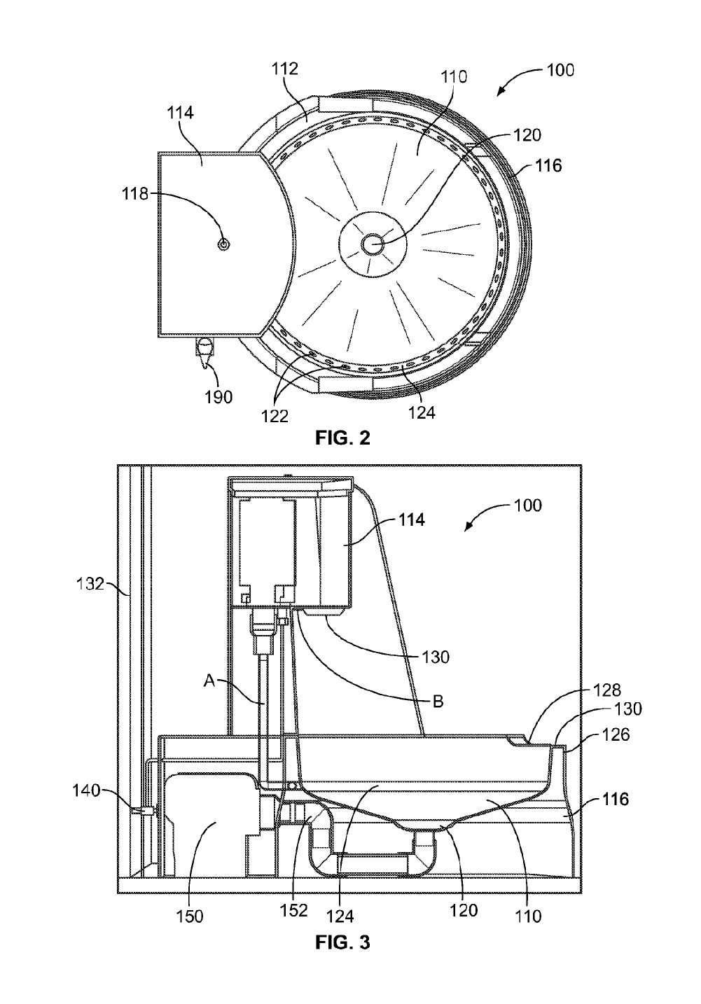

FIG. 1 is an illustration of a perspective view of a pet toilet according to an exemplary embodiment of the present disclosure and FIG. 2 is an illustration of a top view of a pet toilet according to an exemplary embodiment of the present disclosure. The pet toilet 100 can have a standing surface 110 on which a pet can stand, a side wall 112 and a drain 120. The standing surface 110 can be of any size to incorporate various size domestic pets, such as dogs. The standing surface 110 can be provided on top of a base 116, and can have a concave or flat surface. The side wall 112 can have a concave, curved or flat vertical surface, and can be adjacent to the standing surface 110 along a rear circumference of the standing surface. The side wall 112 can be unitary with the standing surface 110 or a separate element. The side wall 112 can be located along a rear portion of the circumference of the standing surface 110, and can extend along a length of a portion of the circumference of the standing surface 110. In some embodiments, the side wall 112 can be located along 10%-75% of the circumference of the standing surface 110, and preferably less than 50%. The standing surface 110 and/or the side wall 112 can be imbedded with anti-microbial material.

In some exemplary embodiments, a rim tube 124 connected to a flush tube (described further below) can be provided. The rim tube 124 can be provided around an entire circumference of the standing surface 110, or along one or more portions of the circumference of the standing surface 110. The rim tube 124 can have one or more water outlets 122 provided and spaced around the rim tube 124. The water outlets 122 can be angled for a water flow that runs clockwise or counterclockwise to push waste effectively off the standing surface 110 and down the drain 120. In some exemplary embodiments, the rim tube 124 can be provided on the side wall 112, or the standing surface 110, or any portion of a side wall surrounding the standing surface 110. In some exemplary embodiments the rim tube may not be visible from an exterior of the pet toilet except for one or more water outlets 122 at the end of the rim tube 124. In some exemplary embodiments, a single water outlet 122 may be provided on the rim tube 124 which can be connected to a power flush to allow for a strong water flush. The single water outlet 122 can be provided at an angle parallel to the curve of the standing surface 110 to disperse the entire volume of water and create a centrifugal flow to optimize the flush power of the water. The rim tube 124 can have one larger water outlet 122 or several smaller water outlets 122 provided on the rim tube 124 or along the circumference of the rim tube 124.

FIG. 3 is an illustration of a cross-section of a side view of a pet toilet according to an exemplary embodiment of the present disclosure. The pet toilet 100 can be provided against a wall 132 and connected to a water supply 140. The water supply 140 can have a shut off valve, such as behind the pet toilet 100 so that it is not exposed. The water supply 140 can be connected to one or more flush tubes, such as flush tube A and flush tube B. The flush tubes A and B can provide a power flush that can allow an amount of water to flush and to cover the entire surface area of the standing surface 110 and/or the side wall 112. The flush tube A can provide for provide a power flush providing water to the rim tube 124 to the one or more water outlets 122 provided in the rim tube 124, to allow for a flush of the standing surface 110 to remove waste. The flush tube B can have one or more water outlets on the side wall 112 which can provide for a flush of the side wall 112 by allowing a smaller stream of water to flush waste down the side wall 112. In some exemplary embodiments, the rim tube 124 can extend from the flush tube A within the housing, so only a single water outlet 122 is visible on the exterior of the pet toilet 100, and the rim tube A provides water to the single water outlet 122 from the flush tube A.

In some exemplary embodiments, a sprayer 190 can be provided to wash or clean the side wall 112 and the standing surface 110. The sprayer 190 can also be used to wash or shower the pet, and can have a retractable hose disposed within the pet toilet 100 or an exposed hose that can hang on the pet toilet 100. In some exemplary embodiments, a single flush tube (e.g., flush tube A) can be provided to clean the standing surface 110 and the sprayer 190 can be used only when the side wall 112 needs to be cleaned. This can allow for conservation of water so that the side wall 112 is not flushed when, e.g., a female dog or pet uses the pet toilet 100. In some exemplary embodiments, a manual flush 118 can also be provided on, e.g., the tank 114 or along any outer surface of the pet toilet 100.

The drain 120 can be provided, e.g., along a center portion of the standing surface 110. The standing surface 110 can have a concave shape so that the drain 120 is provided along a lowest portion of the standing surface 110. The standing surface 110 can be angled anywhere from 1 to 45 degrees, and preferably between 3 to 18 degrees, to allow the waste to flow into the drain 120. The drain 120 can have a diameter that can range in size from one inch to five inches, and can have a 2 ½ in. diameter in some embodiments. The drain 120 can have a U-bend to prevent odors or gases from returning to the environment.

A macerator 150 having a pump can be provided in or near the base 116 of the pet toilet 100. The macerator 150 can make slurry of the waste to move it over a long distance to a sewer drain. The macerator 150 can have an inlet 152 connected to the drain 120, and an outlet (not shown) connected to a sewer line to where the slurry is deposited. The macerator 150 can be electric (and can have a battery backup) or battery operated.

In some exemplary embodiments, the pet toilet 100 can be connected to an existing drain. For example, the macerator 150 can have a secondary outlet to provide an outlet in case an outlet to a sewer line is not readily available for the pet toilet 100. The secondary outlet can be connected to, e.g., a drain of an existing device having an outlet to a sewer line (such as but not limited to a sink, tub, shower or washing machine). For example, the secondary outlet can be connected to a tube that connects with a sewer outlet of the existing device. In some exemplary embodiments, the pet toilet 100 can also be provided as an outdoor unit that can be installed and attached to existing plumbing. The macerator 150 and/or other plumbing provided within or near the pet toilet 100 can be modified or adjusted to accommodate different plumbing codes.

In some exemplary embodiments, one or more motion sensors 130 can be provided under the tank 114, and/or along a wall opposite the side wall 112 above standing surface 110. The one or more motion sensors 130 can be used to know when a pet is using the pet toilet 100 so to know when to flush the pet toilet 100 automatically. For example, one or more motion sensors 130 can be provided under the tank 114 to trigger an auto flush after a broken infrared beam from a pet stepping onto the unit (e.g., standing surface 110) is returned to a full beam from the pet stepping off. The removal of the dog or pet can trigger the auto flush. In some exemplary embodiments, one or more motion sensors 130 can also be provided along an inner portion of top wall 126 to detect a pet on the standing surface 110. In some exemplary embodiments, only the top wall 126 can have one or more motion sensors 130 (i.e., no motion sensors 130 are provided under the tank 114). A manual override flush mechanism 118 can also be provided to provide a flush when needed.

In some exemplary embodiments, a concentrated disc of attractant can be provided in the water tank 114 to provide a scent for dogs or pets to encourage them to use the unit. The attractant disc can be designed to provide a scent for a certain number of flushes, and a new attractant disc can be provided after a certain number of flushes or time frame. The attractant can also be provided as a spray to spray onto the unit, such as on the standing surface 110. The spray can be provided automatically after each flush as a built in function of the pet toilet, or can be provided in the water (when used as a disc) during each flush. An attractant disc can also be provided in solid form and can be attached to the outside of the pet toilet 100, such as on the side of the tank 114 or approximate to or on the base 116.

Various other considerations can also be addressed in the exemplary applications described according to the exemplary embodiments of the present disclosure. The exemplary embodiments of the present disclosure can be used in various configurations and in different systems. For example, the pet toilet can be provided in existing bathrooms of homes, hotels and public facilities (e.g., parks), or in laundry rooms, such as in apartment or other residential buildings. The draining system can be separate for the pet toilet, or can link in to existing draining systems. The pet toilet can also be connected to an existing toilet drain with a flange where the macerator would not be needed. Various minor modifications can be made to the existing drainage systems to connect the pet toilet to a drainage system. In some exemplary embodiments, the pet toilet can use water for the flushing of the pet toilet from a grey water system to conserve water, such as used water from, e.g., a sink, shower or washing machine.

In some exemplary embodiments, the top wall 126 can have a dip or cutout portion 128 to allow the pet to have easier access to the standing surface 110. The cutout portion 128 may be 1-6 inches in height. The pet toilet can be manufactured in various sizes (e.g., height, widths and lengths) based on the type of pet, as well as the size of the pet. The size and height of the standing surface can also be varied based on the size of the pet. In some exemplary embodiments, a ramp can be provided for smaller pets allowing access to the standing surface 110. In some embodiments, the height of the standing surface may be adjustable for use with different pets. The size of the various plumbing may also be modified or manufactured based on amount of use (e.g., household use or heavy use such as in a laundry room of a residential building or public use such as a park). A back panel door may be provided in the base of the pet toilet 100 for servicing of the macerator or other plumbing, as well as in the tank or other part(s) of the pet toilet 100.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure. The disclosures of all systems, documents and publications cited herein are hereby incorporated herein by reference in their entireties.

What is claimed is:

1. A pet toilet, comprising:
a base;
a standing surface provided on the base configured to allow a pet to stand on the standing surface;
a first flush mechanism to provide water for flushing the standing surface;
a rim tube connected to the first flush mechanism configured to provide water from the first flush mechanism to the standing surface; and
at least one water outlet disposed on the rim tube for providing water from the first flush mechanism to the standing surface.

2. The pet toilet of claim 1, wherein the standing surface has a concave surface.

3. The pet toilet of claim 1, further comprising:
a drain provided in the standing surface configured for removal of pet waste and water from the water outlet.

4. The pet toilet of claim 3, wherein the drain is located at a lowest portion of the standing surface.

5. The pet toilet of claim 1, further comprising:
a tank for providing water flow to the first flush mechanism.

6. The pet toilet of claim 4, further comprising:
one or more motion sensors provided underneath the tank for detection of a pet on the standing surface.

7. The pet toilet of claim 6, wherein upon detection of a pet leaving the standing surface the one or more motion sensors trigger the first flush mechanism.

8. The pet toilet of claim 1, further comprising:
a side wall located adjacent to the standing surface along a rear circumference of the standing surface.

9. The pet toilet of claim 8, wherein the side wall is located along approximately less than 50% of the circumference of the standing surface.

10. The pet toilet of claim 8, wherein the side wall is substantially vertical and has a curved surface.

11. The pet toilet of claim 10, further comprising:
a second flush mechanism for flushing the side wall of the pet toilet.

12. The pet toilet of claim 8, further comprising:
one or more motion sensors provided along an inner surface of a top wall opposite the side wall for detection of a pet on the standing surface.

13. The pet toilet of claim 12, wherein upon detection of a pet leaving the standing surface the one or more motion sensors trigger the second flush mechanism.

14. The pet toilet of claim 1, wherein the rim tube is provided along at least a portion of a circumference of the standing surface.

15. The pet toilet of claim 14, further comprising:
several water outlets provided along the rim tube.

16. The pet toilet of claim 1, wherein the at least one water outlet disposed on the rim tube provides water flow at an angle to provide clockwise or counterclockwise water flow on the standing surface.

17. The pet toilet of claim 1, further comprising:
a cutout portion on the base allowing a pet access to the standing surface.

18. The pet toilet of claim 1, further comprising:
a sprayer attached to the pet toilet that provides a water outlet for cleaning the pet toilet.

19. The pet toilet of claim 1, further comprising:
a macerator for receiving waste from the standing surface.

20. The pet toilet of claim 18, wherein the macerator is configured to be connected to an existing sewer line.
